(19) United States
(12) Patent Application Publication
(10) Pub. No.: US 2026/0112990 A1
(43) Pub. Date: Apr. 23, 2026

(54) METHOD FOR CONTROLLING AN ELECTRIC MACHINE SYSTEM DURING FAIL-SAFE MODE

(71) Applicant: Garrett Transportation I Inc., Torrance, CA (US)

(72) Inventors: Najib Rouhana, Thaon-les-Voges (FR); Ali Najmabadi, Redondo Beach, CA (US)

(73) Assignee: Garrett Transportation I Inc., Torrance, CA (US)

(21) Appl. No.: 18/921,071

(22) Filed: Oct. 21, 2024

(51) Int. Cl. H02P 29/028

(52) U.S. Cl. CPC H02P 29/028

(57) ABSTRACT

A method for operating an e-machine system with an electric machine is disclosed. The e-machine system has an operational mode and a fail-safe mode for the electric machine. The method includes providing a plurality of switching elements operably coupled to the electric machine and having a plurality of configurations, including an operational configuration for the operational mode, a freewheel configuration for the fail-safe mode, and an active short-circuit configuration for the fail-safe mode. The method includes receiving, by a processor, a fault indication of the e-machine system and selectively switching, in response to receiving the fault indication, the plurality of switching elements in the fail-safe mode, including selectively modulating the plurality of switching elements between the freewheel configuration and the active short-circuit configuration.

### TECHNICAL FIELD

The present disclosure generally relates to an electric (e-machine) system, such as those including electric motors or other e-machines and, in particular, relates to a method for controlling an e-machine system during a fail-safe mode thereof.

### BACKGROUND

Various e-machine systems are proposed for a number of uses. For example, e-machine systems may include an electric motor, e.g. for a traction drive in an electric or hybrid vehicle. Some e-machine systems may be configured for fuel-cell systems. Other e-machine systems may be configured for electrical power generation, etc. Preferably, these e-machine systems provide efficient, effective, and useful operation.

A fault may occur during operation of an e-machine system. Faults may occur due to a hardware failure, due to supply voltage breakdown, or otherwise. Preferably, the e-machine system includes fault management features for avoiding damage to the system during the fault condition.

However, it may be difficult to provide fault management features that are effective for a wide range of conditions. Some may be effective for some fault conditions and less effective for other fault conditions. Furthermore, providing fault management features may be costly and difficult. Extra parts (e.g., extra sensors or other hardware) may be needed, which increases manufacturing costs and time. Incorporating fault management features may present other disadvantages as well.

Thus, it is desirable to provide an e-machine system that can effectively manage a wide range of fault conditions and protect the e-machine system during these events. It is also desirable to provide such an e-machine system at less cost. Furthermore, it is desirable to provide such an e-machine system with increased manufacturability. Other desirable features and characteristics of the present disclosure will become apparent from the subsequent detailed description and the appended claims, taken in conjunction with the accompanying drawings and this background discussion.

### BRIEF SUMMARY

In one embodiment, a method for operating an e-machine system with an electric machine is disclosed. The e-machine system has an operational mode and a fail-safe mode for the electric machine. The method includes providing a plurality of switching elements operably coupled to the electric machine and having a plurality of configurations, including an operational configuration for the operational mode, a freewheel configuration for the fail-safe mode, and an active short-circuit configuration for the fail-safe mode. The method includes receiving, by a processor, a fault indication of the e-machine system and selectively switching, in response to receiving the fault indication, the plurality of switching elements in the fail-safe mode, including selectively modulating the plurality of switching elements between the freewheel configuration and the active short-circuit configuration.

In another embodiment, a device for operating an e-machine system with an electric machine is disclosed. The e-machine system has an operational mode and a fail-safe mode for the electric machine. The device includes an inverter, with a plurality of switching elements operably coupled to the electric machine and having a plurality of configurations, including an operational configuration for the operational mode, a freewheel configuration for the fail-safe mode, and an active short-circuit configuration for the fail-safe mode. The system also includes a processor configured to receive a fault indication of the e-machine system. The plurality of switching elements is configured to, in response to the processor receiving the fault indication, selectively switch in the fail-safe mode, including selectively modulating between the freewheel configuration and the active short-circuit configuration.

In a further embodiment, a method for operating an e-machine system with an electric motor is disclosed. The e-machine system has an operational mode and a fail-safe mode for the electric motor. The method includes providing a plurality of switching elements operably coupled to the electric motor and having a plurality of configurations, including an operational configuration for the operational mode, a freewheel configuration for the fail-safe mode, and an active short-circuit configuration for the fail-safe mode. Furthermore, the method includes receiving, by a processor from a memory device, a predetermined fail-safe strategy. The method further includes receiving, by a processor, a fault indication of the e-machine system and selectively switching, in response to receiving the fault indication, the plurality of switching elements in the fail-safe mode, including selectively modulating the plurality of switching elements between the freewheel configuration for a predetermined percentage of a time period and the active short-circuit configuration for a remainder of the predetermined percentage of the time period according to the received predetermined fail-safe strategy.

### BRIEF DESCRIPTION OF THE DRAWINGS

The present disclosure will hereinafter be described in conjunction with the following drawing figures, wherein like numerals denote like elements, and wherein:

FIG. 1 is a schematic view of an e-machine system according to example embodiments of the present disclosure;

FIG. 2 is a schematic view of the e-machine system in a freewheel fail-safe mode according to example embodiments of the present disclosure;

FIG. 3 is a schematic view of the e-machine system in an active short-circuit fail-safe mode according to example embodiments of the present disclosure;

FIG. 4 is a schematic view of the e-machine system in an active short-circuit fail-safe mode according to additional example embodiments of the present disclosure;

FIG. 5 is a flowchart illustrating a method of operating the e-machine system; and

FIG. 6 is a diagram illustrating aspects of the method of FIG. 5.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the embodiments of the e-machine system are merely example embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Broadly, example embodiments disclosed herein relate to an electric machine (i.e., “e-machine”) system and a method of operating the same. Features of the e-machine system and its method of control may be used to selectively switch the system from an operational mode to a fail-safe mode in response to a detected fault (i.e., fault condition). In the fail-safe mode, a plurality of switching elements of an inverter may be selectively modulated between a freewheel configuration and an active short-circuit configuration according to a predetermined fail-safe strategy. A processor of a control system of the e-machine system may control the switching elements using pulse width modulation according to the predetermined fail-safe strategy when in the fail-safe mode. When in the free-wheel configuration, all the switching elements are maintained open, and the flow of energy is eliminated if the DC voltage at the input is higher than the peak voltage of the e-machine back electromotive force (BEMF). When in the active short-circuit configuration, all phase connections of the machine are electrically connected to one another and the power supply is isolated from the e-machine. In that case, the flow of energy is circulating only between the controller and the e-machine. According to the present disclosure, risk of failure of the switching elements due to high transient current at the moment of application of the active short-circuit configuration may be mitigated. The fail-safe strategy applied may be chosen to provide benefits of both the free-wheel and active short-circuit configurations while also mitigating disadvantageous effects. The fail-safe strategy may be applied for effectively managing a wide variety of fault conditions for the e-machine system. These features may be provided at relatively low cost. The e-machine system of the present disclosure may also provide a number of manufacturing efficiencies.

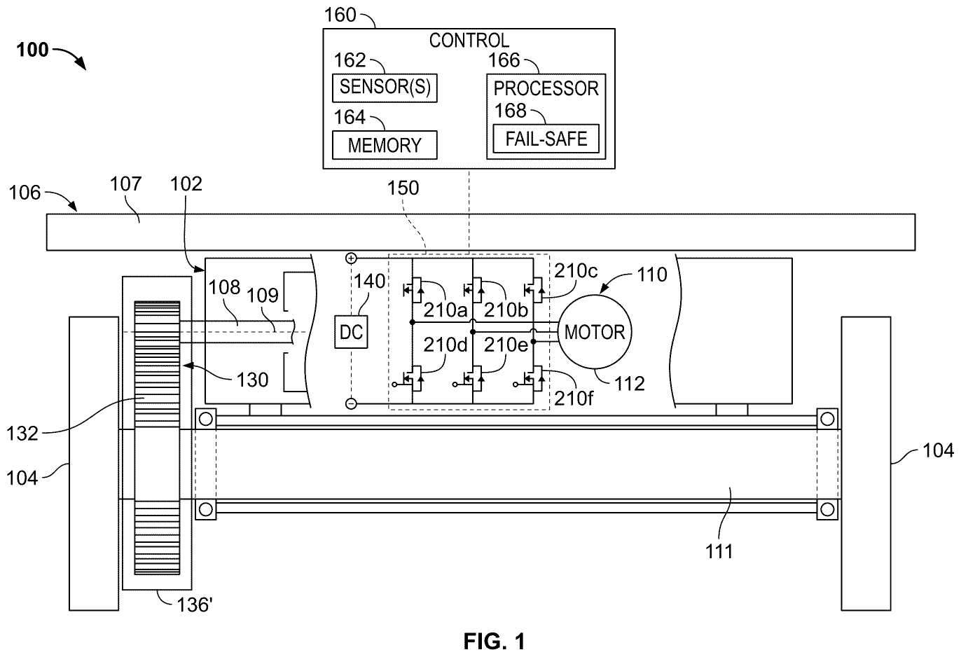

FIG. 1 is a schematic view of an e-machine system 100 according to example embodiments of the present disclosure. The e-machine system 100 may have a variety of configurations. In some embodiments, the e-machine system 100 may be configured as a traction drive system 102 that is included, for example, on a vehicle 106. Thus, the traction drive system 102 may be configured for driving one or more wheels 104 of the vehicle 106. More specifically, the wheels 104 may be included at opposite ends of an axle 111, and a chassis 107 may be supported on the wheels 104 by a suspension system (not shown). It will be appreciated that the e-machine system 100 may be configured for driving an input member of a differential, which is operatively attached to the wheels 104. The vehicle 106 may be an electric car, truck, van, motorcycle, boat, or other vehicle. The e-machine system 100 may be incorporated within a fuel cell system in some embodiments. However, it will be appreciated that the e-machine system 100 may be configured otherwise without departing from the scope of the present disclosure.

The e-machine system 100 may include an e-machine 110, which may relate to or comprise a synchronous machine, such as a permanently excited synchronous machine. Furthermore, other e-machines, such as an asynchronous machine, etc. may be included without departing from the scope of the present disclosure.

The e-machine 110 may comprise an electric motor 112; however, it will be appreciated that the e-machine 110 may be configured as an electric generator. Furthermore, the e-machine 110 may be operable in some situations as a motor and in additional situations as a generator. The electric motor 112 may include a rotor member and a stator member that are housed within a motor housing and operably coupled for driving an output shaft 108 in rotation about an axis 109. In exemplary embodiments illustrated in the Figures, the electric motor 112 comprises a three-phase electric motor 112. It will be appreciated that other electric motors 112 may be incorporated without departing from the scope of the present disclosure. Thus, electric motors 112 or other e-machines 110 with another number of phase connections also fall within the scope of the present disclosure.

Also, the e-machine system 100 may include a transmission 130. The transmission 130 may generally include a geartrain 132 that is housed within a gearbox housing 136. The geartrain 132 may be of any suitable type. The geartrain 132 may operatively connect the output shaft 108 of the e-machine 110 and the axle 111 and may provide a chosen gear ratio therebetween.

Furthermore, the e-machine system 100 may also include a control system 160 for controlling operations of the motor 112 and/or other features of the e-machine system 100. The control system 160 may comprise a computerized control system with a processor 166, one or more sensors 162, and one or more memory devices 164.

The control system 160 may include and/or be in communication with an inverter 150 of the e-machine system 100. The inverter 150 may comprise a plurality of switching elements 210a-210f. The switching elements 210a-210f may comprise semiconductor switching elements, such as, for example, insulated-gate bipolar transistors (IGBTs) or metal-oxide-semiconductor field-effect transistor (MOSFETs). There may be six switching elements 210a, 210b, 210c, 210d, 210e, 210f, with a first set 212 of three of the switching elements 210a, 210b, 210c disposed on one side (i.e., a high side, positive side, etc.) of a DC bus 140 and a second set 214 of the other three switching elements 210d, 210e, 210f disposed on the other side (i.e., a low side, negative side, etc.) of the DC bus 140.

The sensor(s) 162 may be configured, for example, for detecting, ascertaining, sensing, etc. one or more parameters, operation conditions, etc. of the e-machine system 100. For example, the sensor(s) 162 may detect, ascertain, sense, etc. the current rotational speed of the shaft 126, the axle 111, etc. The sensor(s) 162 may be configured to detect voltage ratios or phase currents within the inverter 150, etc. One or more of the sensors 162 may be configured, generally, for detecting a fault condition of the e-machine system 100. For example, the sensors 162 may be configured for detecting voltage ratios, phase currents, or other condition that indicates a fault condition due to part failure, supply voltage breakdown, or other failure.

The memory device 164 may comprise any suitable computerized memory device (e.g., RAM, ROM, etc.). The memory device 164 may be configured for storing a variety of data, programmed logic, etc., for managing a fault condition of the system 100. Also, the memory device 164 may be configured for storage of predetermined thresholds, standards, or conditions indicative of a fault condition of the system 100.

The processor 166 may be of any suitable type and may be in communication with both the sensors 162 and the memory device 164. The processor 166 may receive input from the sensors 162, and the processor 166 may access the memory device 164 for stored instructions, etc., so that the processor 166 may, in turn, evaluate conditions of the e-machine system 100. Furthermore, the processor 166 may output various control signals for controlling the e-machine system 100 according to the evaluation.

The control system 160 may operate the e-machine system 100 in at least one operational mode (i.e., normal mode, motoring mode, etc.), in which the electric motor 112 rotatably drives the output shaft 108 at a controlled speed, acceleration, etc. This rotational power may transfer to the geartrain 132, which may transmit the power to the axle 111 to rotate the wheels 104 and propel the vehicle 106.

More specifically, the inverter 150 may be fed with electrical energy, e.g., a direct-current (DC) voltage. The DC voltage may, for example, originate from an electrical energy supply, such as a battery, via a DC bus 140. Alternative options for providing an electrical voltage are also possible within the scope of the present disclosure. The control system 160 may use DC voltage from the DC bus 140 to power the motor 112 using the inverter 150 (as well as a rectifier and a DC link).

In one or more modes of the e-machine system 100, the processor 166 may access the memory device 164 (e.g., to access control programming, etc.) and/or receive sensor output (e.g., feedback) from the sensors 162, and the processor 166 may, in turn, output control signals to the plurality of switching elements 210a-210f. The switching elements 210a-210f may be selectively switched between respective closed (ON) and open (OFF) positions. In some embodiments, the processor 166 may selectively change the mode of the system 100 by switching the switching elements 210a-210f based on output from the sensor(s) 162 as correlated to predefined target values, models, etc. stored in the memory device 164.

Collectively, the switching elements 210a-210f may be arranged in one or more “operational configurations,” and the inverter 150 may convert the voltage provided by the DC bus 140 (i.e., at the input) to AC voltage that is provided to the motor 112 or vice versa if the switching elements 210a-210f are reversible in current. The “operational configuration” of the switching elements 210a-210f may change during operation of the system 100. The inverter 150 may provide suitable AC voltage signals at the phase connections of the electric motor 112 to operate at a predefined rotational speed, predefined torque, etc.

As will be discussed, the control system 160 may be configured for pulse width modulation (PWM) for controlling and switching the switching elements 210a-210f between various configurations. The processor 166 may rely on the pulse width modulation technique to control the switching elements 210a-210f by varying the width of a rectangular control signal waveform (i.e., a digital signal that uses a series of on-off pulses to control the input voltage) as will be discussed in detail below.

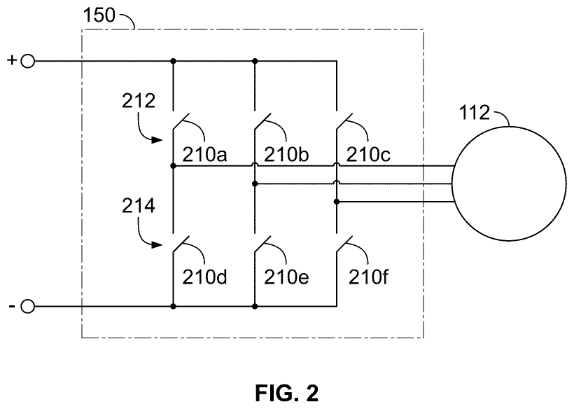

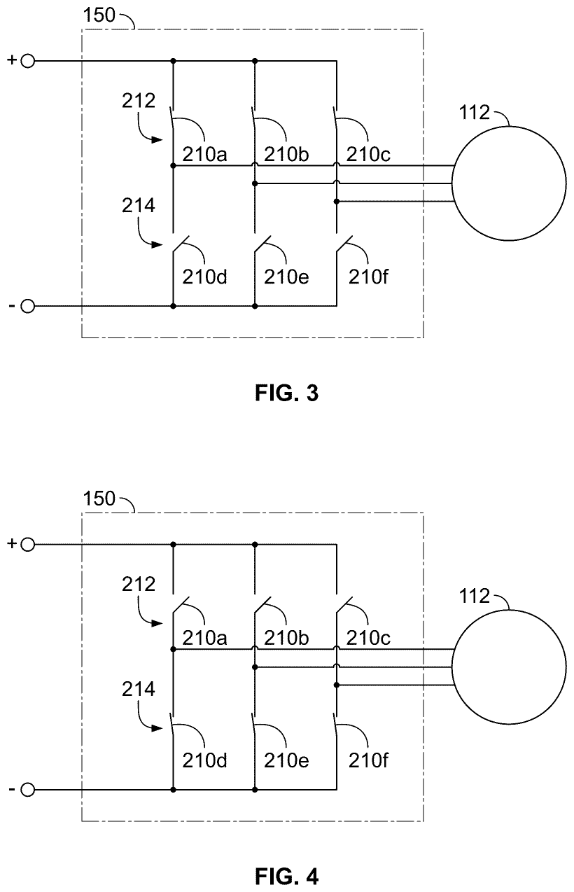

The e-machine system 100 may experience a fault (i.e., fault condition, etc.). Accordingly, the processor 166 may comprise a fail-safe module 168 for operating the e-machine system 100 in a fail-safe mode (as opposed to the operational mode mentioned above). Generally, the fail-safe module 168 may recognize a fault indication based on sensor input from the sensors 162, and the processor 166 may, in turn, change from the operational mode of the e-machine system 100 to a fail-safe mode. In the fail-safe mode, the fail-safe module 168 may generate and output control signals for selectively switching the switching elements 210a-210f to one or both of a freewheel configuration (FIG. 2) and an active short-circuit configuration (FIGS. 3 and 4).

In FIGS. 2, 3, and 4, the switching elements 210a, 210b, 210c, 210d, 210e, and 210f are depicted as simple switches for the purpose of clarity. In FIG. 2, the switching elements 210a-210f may relate to a semiconductor switch having a freewheel diode connected in parallel thereto. In the free-wheel configuration illustrated in FIG. 2, all of the switching elements 210a-210f are open. Hence, no voltage is provided at the electric motor 112. If the back-EMF peak voltage is less than the DC-bus voltage, then energy flow from the DC side to the AC side is reduced to zero nearly instantaneously.

In the first active short-circuit configuration of FIG. 3, the first set 212 of switching elements 210a, 210b, 210c are positioned and maintained closed while the second set 214 of switching elements 210d, 210e, 210f are positioned and maintained open. Hence, the phase connections of the electric motor 112 are electrically connected to one another via the first set 212 of switching elements 210a, 210b, and 210c and are, therefore, short-circuited.

Conversely, in the second active short-circuit configuration of FIG. 4, the first set 212 of switching elements 210a, 210b, 210c are positioned and maintained open while the second set 214 of switching elements 210d, 210e, 210f are positioned and maintained closed. Accordingly, the phase connections of the electric motor 112 are electrically connected to one another via the second set 214 of switching elements 210d, 210e, and 210f and are, therefore, short-circuited.

In both active short-circuit configurations of FIGS. 3 and 4, energy may be exchanged between the inverter 150 and the electric motor 112. This fail-safe mode may advantageously decelerate the electric motor 112 toward a complete stop more quickly than in the case of the freewheel configuration of FIG. 2.

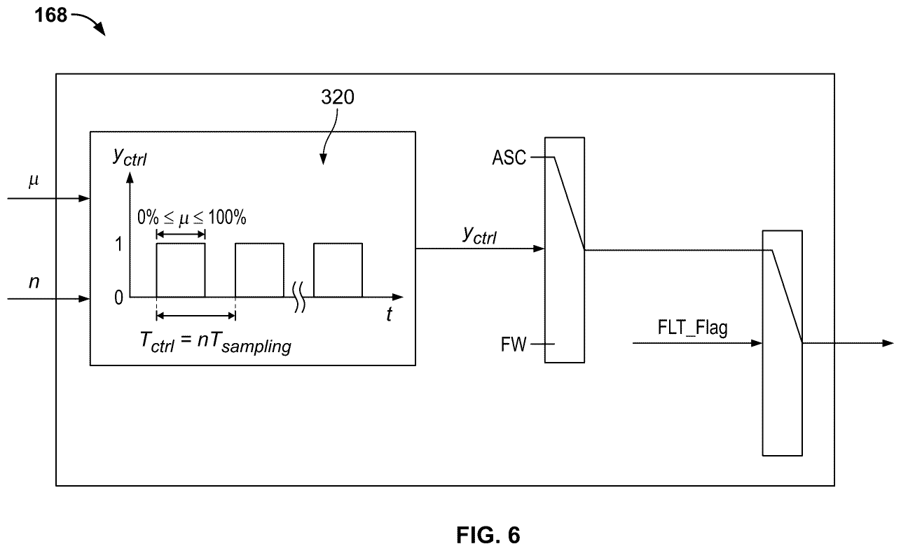

Moreover, to limit the duration and amplitude of the short-circuit current when in the active short-circuit configuration (FIG. 3 and/or FIG. 4), the fail-safe module 168 may modulate and selectively switch the switching elements 210a-210f between the freewheel configuration FIG. 2 and at least one of the active short-circuit configurations of FIGS. 3 and 4. The control system 160 may modulate according to a selected fail-safe strategy 320 (FIG. 6) that may be stored in the memory device 164. The memory device 164 may store a plurality of fail-safe strategies 320 (i.e., algorithms, etc.), each with different set parameters for modulating between the freewheel and active short-circuit configurations. In additional embodiments, the memory device 164 may store a fail-safe strategy 320, parameters of which may be selectively adjusted for varying the modulation between freewheel and active short-circuit configurations (e.g., for varying the percentage of time that freewheel and active short-circuit configurations are applied during a time period). Thus, the fail-safe module 168 may protect the inverter 150 from transient over-current that could otherwise occur during the active short-circuit configuration. Also, the fail-safe module 168 may be adjusted for a wide range of fault conditions.

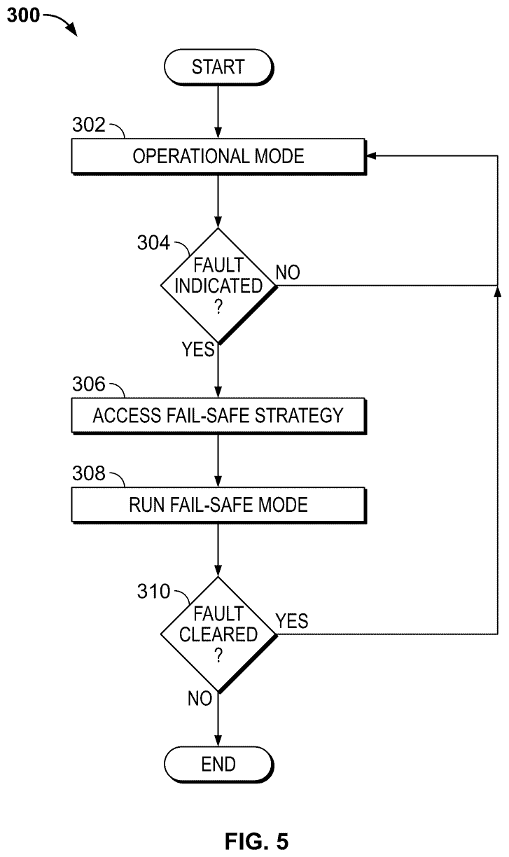

Referring now to FIGS. 5 and 6, a method 300 of operating the e-machine system 100 will be discussed according to example embodiments. The method may begin at 302, and the system 100 may default to an operational mode. The control system 160 may operate the inverter 150 in a known manner in the operational mode of 302 such that the electric motor 112 rotatably drives the output shaft 108, for example, to rotate the wheels 104 and propel the vehicle 106 of FIG. 1.

Then, at determination block 304, the control system 160 determines whether a fault is indicated. For example, the processor 166 may receive and analyze input from the sensors 162 to determine whether a fault is indicated. The processor 166 may access the memory device 164 to make this determination. The memory device 164 may have a known algorithm, preprogrammed logic, threshold values, etc. stored thereon, and the processor 166 may process sensor input from the sensors 162 according to the information stored on the memory device 164 to determine whether a threshold condition has been reached (e.g., excessive voltage, etc.) indicating that a fault has occurred in the system 100.

As long as the processor 166 determines that no fault is detected (block 304 answered negatively), the method 300 may loop back to 302, and the system 100 may remain in the operational mode. However, if the processor 166 determines a fault has occurred (block 304 answered positively), the method 300 may continue to 306, and the fail-safe module 168 may progress to block 306 and initiate operation of the e-machine system 100 in a fail-safe mode.

More specifically, at 306, the fail-safe module 168 of the processor 166 may access the memory device 164 for a predetermined, preset, stored fail-safe strategy 320, such as the fail-safe strategy 320 represented in FIG. 6. As shown, the fail-safe strategy 320 may comprise a rectangular control signal waveform that modulates between the freewheel (“FW”) configuration (FIG. 2) and the active short-circuit (“ASC”) configuration (FIGS. 3 and/or 4). The strategy 320 may depend upon a preselected modulation index, μ, and integer, η, as shown. Thus, the control system 160 may apply the freewheel configuration (FIG. 2) for a certain percentage of a preselected time period, T_{ctrl}, and the active short-circuit configuration (FIGS. 3 and/or 4) for the remainder of the time period according to the fail-safe strategy 320.

The method 300 may progress to 308, at which the fail-safe module 168 of the processor 166 operates the inverter 150 according to the fail-safe strategy 320 accessed at 306. In some embodiments represented in FIG. 6, the processor 166 may generate and provide a control signal y_{ctrl} to modulate and switch the plurality of switching elements 210a-210f between the freewheel (“FW”) configuration of FIG. 2 and the active short-circuit (“ASC”) configuration of FIG. 3 according to a modulation index, μ, that ranges between zero (0) and one (1), where:

$${y}_{ctrl} = μ * ASC + ( 1 - μ ) * FW$$

Thus, the active short-circuit configuration may be applied for a percentage of the time period of the signal, and the freewheel configuration may be applied for the remainder of the time period.

Other embodiments fall within the scope of the present disclosure. For example, the processor 166 may generate and provide the control signal y_{ctrl} to modulate and switch the plurality of switching elements 210a-210f between the freewheel (“FW”) configuration of FIG. 2 and the active short-circuit (“ASC”) configuration of FIG. 4.

In further embodiments, the fail-safe strategy 320 may be such that the processor 166 modulates and switches the plurality of switching elements 210a-210f between the freewheel (“FW”) configuration of FIG. 2, the first active short-circuit (“ASC”) configuration of FIG. 3, and the second active short-circuit (“ASC”) configuration of FIG. 4. For example, in a single time period or cycle of the signal, the switching elements 210a-210f may switch from the first active short-circuit (“ASC”) configuration of FIG. 3, to the freewheel (“FW”) configuration of FIG. 2, and subsequently to the second active short-circuit (“ASC”) configuration of FIG. 4, and this sequential pattern may be repeated during the fail-safe mode. In such embodiments, the switching elements 210a-210f may alternate between the first and second active short-circuit (“ASC”) configurations (as interrupted by the freewheel configuration of FIG. 2) to more equally distribute the heat losses between the first set 212 and the second set 214 of switching elements 210a-210f.

Accordingly, in the fail-safe mode, the electric motor 112 may be decelerated quickly while also limiting the duration and amplitude of the short-circuit current between the inverter 150 and the electric motor 112. As such, the control system 160 and the method 300 of operating the e-machine system 100 may be well protected and robust.

The method 300 may continue to 310, where the processor 166 determines whether the fault condition has cleared. For example, the processor 166 may receive further input from the sensors 162 indicating that the fault condition has passed. If the fault has been cleared (i.e., decision block 310 answered affirmatively), the method 300 may loop back to 302 where the control system 160 operates the inverter 150 normally, and operational mode of the system 100 resumes. Otherwise, the method 300 may terminate if the fault condition persists (decision block 310 answered negatively).

Furthermore, one or more inputs, variables, factors, etc. to the fail-safe strategy 320 may be selected, adjusted, chosen, etc. to vary the control signal, y_{ctrl}, generated and output by the processor 166 to the switching elements 210a-210f of the inverter 150. For example, in some embodiments, one or more of the variables of the strategy 320 (e.g., the modulation index, μ, the period, T_{cnrl}, and/or the integer η) may be preselected and stored in the memory device 164 for use at 306 of the method 300. In so doing, the percentage of the time period for applying the freewheel configuration (and the inverse percentage of the time period for applying the active short-circuit configuration) may be preselected and chosen for use at 306 of the method 300. Thus, the control signal, y_{ctrl}, from the processor 166 may be selectively changed, modified, tailored, and selected using pulse width modulation.

Moreover, in some embodiments, the memory device 164 may have stored thereon a plurality of different fail-safe strategies 320. The different fail-safe strategies 320 may have different modulation patterns, or other differences. One of the strategies 320 may be preselected for use at 306 of the method 300. Accordingly, the fail-safe strategy 320 may be tailored and adjusted for a particular system 100.

It will also be appreciated that, in addition to modulating between the different fail-safe configurations of FIGS. 2, 3, and 4, the same fail-safe strategy 320 may be configured for maintaining one of those configurations for the entire time period. Specifically, by setting the modulation index, μ, at a value of one (1), the processor 166 may generate and output the control signal, y_{ctrl}, for the active short-circuit configuration during the entire time period (100% ASC). Conversely, by setting the modulation index, μ, at a value of zero (0), the processor 166 may generate and output the control signal, y_{ctrl}, for the freewheel configuration during the entire time period (100% FW).

Accordingly, the e-machine system 100 may be well-equipped to manage a fault condition. The system 100 and method 300 may provide benefits of both the free-wheel and active short-circuit configurations and also mitigate disadvantageous effects. The system 100 and method 300 may be highly adjustable and configurable for effectively managing a wide variety of fault conditions. The system 100 may be provided at relatively low cost, with relatively few parts, and with highly adaptable programming. Also, the fail-safe management features may be provided advantageously using a low percentage of available computing resources.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It is understood that various changes may be made in the function and arrangement of elements described in an exemplary embodiment without departing from the scope of the present disclosure as set forth in the appended claims.

What is claimed is:

1. A method for operating an e-machine system with an electric machine, the e-machine system having an operational mode and a fail-safe mode for the electric machine, the method comprising:
providing a plurality of switching elements operably coupled to the electric machine and having a plurality of configurations, including an operational configuration for the operational mode, a freewheel configuration for the fail-safe mode, and an active short-circuit configuration for the fail-safe mode;
receiving, by a processor, a fault indication of the e-machine system; and
selectively switching, in response to receiving the fault indication, the plurality of switching elements in the fail-safe mode, including selectively modulating the plurality of switching elements between the freewheel configuration and the active short-circuit configuration.

2. The method of claim 1, wherein selectively switching includes selectively modulating the plurality of switching elements between the freewheel configuration and the active short-circuit configuration according to a predetermined fail-safe strategy stored in a memory device.

3. The method of claim 2, wherein selectively switching includes applying the freewheel configuration for a percentage of a time period and the active short-circuit configuration for a remainder of the time period according to the predetermined fail-safe strategy.

4. The method of claim 3, wherein the predetermined fail-safe strategy is selectively modifiable to modify the modulating of the plurality of switching elements between the freewheel configuration and the active short-circuit configuration.

5. The method of claim 4, further comprising receiving, by the processor, a preselected percentage of the time period; and
wherein selectively switching includes applying the freewheel configuration for the preselected percentage of the time period and the active short-circuit configuration for the remainder of the preselected time period according to the predetermined fail-safe strategy.

6. The method of claim 5, wherein the preselected percentage of the time period is less than 100% and greater than 0%.

7. The method of claim 2, wherein the memory device includes a plurality of fail-safe strategies stored thereon;
further comprising receiving, by the processor, a selection of the predetermined fail-safe strategy from the plurality of fail-safe strategies.

8. The method of claim 2, further comprising receiving, by the processor, the selected predetermined fail-safe strategy from the memory device; and
wherein selectively switching includes selectively modulating the plurality of switching elements between the freewheel configuration and the active short-circuit configuration according to the received selected predetermined fail-safe strategy.

9. The method of claim 1, wherein the plurality of switching elements are arranged in a first set and a second set, the first set and the second set disposed on opposite sides of a DC supply;
wherein the plurality of switching elements has a first active short-circuit configuration in which the first set are closed and the second set are open;
wherein the plurality of switching elements has a second active short-circuit configuration in which the second set are closed and the first set are open; and
wherein selectively switching includes selectively modulating the plurality of switching elements between the freewheel configuration, the first active short-circuit configuration, and the second active short-circuit configuration.

10. The method of claim 1, wherein, the plurality of switching elements are configured to respectively switch open and closed;
wherein the plurality of switching elements are arranged in a first set and a second set, the first set and the second set disposed on opposite sides of a DC supply;
wherein, in the freewheel configuration, each of the plurality of switching elements are open; and
wherein, in the active short-circuit configuration, one of the first set and the second set is open and the other is closed.

11. A device for operating an e-machine system with an electric machine, the e-machine system having an operational mode and a fail-safe mode for the electric machine, the device comprising:
an inverter, with a plurality of switching elements operably coupled to the electric machine and having a plurality of configurations, including an operational configuration for the operational mode, a freewheel configuration for the fail-safe mode, and an active short-circuit configuration for the fail-safe mode;
a processor configured to receive a fault indication of the e-machine system; and
the plurality of switching elements configured to, in response to the processor receiving the fault indication, selectively switch in the fail-safe mode, including selectively modulating between the freewheel configuration and the active short-circuit configuration.

12. The device of claim 11, further comprising a memory device with a predetermined fail-safe strategy stored thereon; and
wherein the plurality of switching elements are configured to selectively switch between the freewheel configuration and the active short-circuit configuration according to the predetermined fail-safe strategy stored in the memory device.

13. The device of claim 12, wherein the plurality of switching elements are configured to selectively apply the freewheel configuration for a percentage of a time period and the active short-circuit configuration for the remainder of the time period according to the predetermined fail-safe strategy.

14. The device of claim 13, wherein the predetermined fail-safe strategy is selectively modifiable to modify the modulating of the plurality of switching elements between the freewheel configuration and the active short-circuit configuration.

15. The device of claim 14, wherein the processor is configured to receive a preselected percentage of the time period; and
wherein the plurality of switching elements are configured to apply the freewheel configuration for the preselected percentage of the time period and the active short-circuit configuration for the remainder of the preselected time period according to the predetermined fail-safe strategy.

16. The device of claim 15, wherein the preselected percentage of the time period is less than 100% and greater than 0%.

17. The device of claim 12, wherein the memory device includes a plurality of fail-safe strategies stored thereon; and
wherein the processor is configured to receive a selection of the predetermined fail-safe strategy from the plurality of fail-safe strategies.

18. The device of claim 11, wherein the plurality of switching elements are arranged in a first set and a second set, the first set and the second set disposed on opposite sides of a DC supply;
wherein the plurality of switching elements has a first active short-circuit configuration in which the first set are closed and the second set are open;
wherein the plurality of switching elements has a second active short-circuit configuration in which the second set are closed and the first set are open; and
wherein the plurality of switching elements are configured to selectively modulate between the freewheel configuration, the first active short-circuit configuration, and the second active short-circuit configuration.

19. The device of claim 11, wherein, the plurality of switching elements are configured to respectively switch open and closed;
wherein the plurality of switching elements are arranged in a first set and a second set, the first set and the second set disposed on opposite sides of a DC supply;
wherein, in the freewheel configuration, each of the plurality of switching elements are open; and
wherein, in the active short-circuit configuration, one of the first set and the second set is open and the other is closed.

20. A method for operating an e-machine system with an electric motor, the e-machine system having an operational mode and a fail-safe mode for the electric motor, the method comprising:
providing a plurality of switching elements operably coupled to the electric motor and having a plurality of configurations, including an operational configuration for the operational mode, a freewheel configuration for the fail-safe mode, and an active short-circuit configuration for the fail-safe mode;
receiving, by a processor from a memory device, a predetermined fail-safe strategy;
receiving, by a processor, a fault indication of the e-machine system; and
selectively switching, in response to receiving the fault indication, the plurality of switching elements in the fail-safe mode, including selectively modulating the plurality of switching elements between the freewheel configuration for a predetermined percentage of a time period and the active short-circuit configuration for a remainder of the predetermined percentage of the time period according to the received predetermined fail-safe strategy.
